(19) United States
(12) Patent Application Publication
(10) Pub. No.: US 2006/0127570 A1
(43) Pub. Date: Jun. 15, 2006

(54) Method for endowing articles with camouflage and articles produced by the camouflage method

(76) Inventors: William Edward Casburn, Allendale, IL (US); Timothy Joe Casburn, Mount Carmel, IL (US)

Correspondence Address: Freddie French;INVENTIONS UNLIMITED, #4406, 575 W. MADISON STREET, CHICAGO, IL, 60661, US

(21) Appl. No.: 11/010,738

(22) Filed: Dec. 13, 2004

(51) Int. Cl. B41M 5/124

(52) U.S. Cl. 427/145

(57) ABSTRACT

Disclosed herein is a method of providing camouflage to articles and articles to which the camouflage method may be applied. The camouflage pattern may include a plurality of light and dark regions. The light regions may be surrounds and enclosed by encircling darker and darker regions. The dark regions may be surrounded and enclosed by encircling lighter and lighter regions. The light and dark regions may be intermittently applied across an article and overlaid upon each other. The light and dark regions may include colors particular to a predetermined region where the camouflages article may be applied. The light and dark regions may also be overlaid with a plurality of light and dark streaks or stripes. The light and dark regions may be placed adjacent to one another to contrast with each other and to mimic the natural play of light and shadow found in nature.

### CROSS-REFERENCE TO OTHER APPLICATIONS

The present application claims the benefit of priority of U.S. Provisional Patent Application having Ser. No. 60/525,947, filed on Dec. 11, 2003, and hereby incorporates herein by reference the complete subject matter thereof, in its entirety.

### FEDERALLY SPONSORED RESEARCH OR DEVELOPMENT

[Not Applicable]

### MICROFICHEICOPYRIGHT REFERENCE

[Not Applicable]

### BACKGROUND OF THE INVENTION

The art of camouflage is as old as man himself. Prehistoric man covered himself with grass and leaves in order to blend in better with his surroundings. Animals have evolved to mimic their surrounds. Plants grow in variety of shapes and multi-colored patterns to attract the attention of desirable creatures and hide from undesirable creatures. In order to become better camouflaged, man has studied nature and adapted the camouflage techniques taught in nature.

Animals and people hide things for various reasons. Animals in nature hide their young to protect them from predators. Pirates hide stolen treasure to protect it from being stolen yet again. One of the most effective ways to hide something is by camouflaging it.

Camouflage is the “art of concealment.” The term camouflage comes from the French word camoufler meaning “to blind or veil.” To camouflage, also called “protective concealment”, means to disguise an object, in plain sight, in order to conceal it from something or someone. Camouflage is often associated with and thought of as being used during war. Soldiers often wear special camouflage clothing and smear mud and grease paint on their faces and exposed skin to become less visible. But, camouflage exists in many other forms in the natural world. A chameleon, for instance, changes color to blend in with its environment. A white polar bear is hard to see on an ice sheet, as is a striped zebra in the African bush.

Camouflage is also very important in hunting. Man has studied the animals that are desirable to hunt and has endeavored to camouflage clothing, equipment, and other paraphernalia to become less visible to animals. The hunter desires to be invisible to the prey while being and remaining in plain sight. Hunting camouflage typically takes of the form or resemblance of the location in which the prey may be found.

Animals and plants often use one of two methods to conceal themselves in nature: general resemblance and special resemblance. With general resemblance, animals and plants use color to blend in with their habitat so that they're almost invisible. Besides chameleons, other animals that use color to match their surroundings include hares, tree frogs, flounder fish, grasshoppers, and lizards. Plants may also adapt to resemble their immediate surroundings.

With special resemblance, animals and plants use a combination of color, shape and behavior to help them appear like something in their habitat. They are simply mistaken for something else. The walking stick is a great example. This insect becomes almost invisible due to the shape of its body, its coloration and its slow movement. It looks and acts just like a twig on a bush or tree. Berries and fruits of many plants are adapted to avoid being eaten, or alternatively, to attract a specific creature to eat the fruit, to the exclusion of other creatures.

Some animals have special markings that help to disguise their shapes. The zebra, for instance, has markings that run off its edges into the background. This feature allows the zebra to fade into the background so successfully that it is difficult to see its overall shape. Consider the confusion a herd of zebras causes a predator. Other animals that use special resemblance to conceal themselves include giraffes, leopards, praying manatees, snakes, butterflies and moths, caterpillars, and spiders.

Further limitations and disadvantages of conventional and traditional approaches will become apparent to one of skill in the art, through comparison of such methods with some aspects of the present invention as set forth in the remainder of the present application with reference to the drawings appended hereto.

### SUMMARY OF THE INVENTION

Aspects of the present invention may be found in a method of camouflaging an article. The method may comprise selecting a foundation material to be camouflaged. The foundation material may have a foundation color. The method may further comprise applying a first pattern comprising a plurality of irregularly shaped areas atop the foundation material. The first pattern may have a first color that is different from the foundation color. The method may further comprise applying a second pattern comprising a plurality of irregularly shaped areas atop the first pattern. The second pattern may have a second color that is different from the first color and the foundation color. The plurality of irregularly shaped areas of the second pattern may be surrounded by at least one of the first color of the first pattern and the foundation color of the foundation material providing contrasting colored regions.

In an embodiment of the present invention, the plurality of irregularly shaped areas of the second pattern may be surrounded by at least both of the first color of the first pattern and the foundation color of the foundation material.

In an embodiment of the present invention, the foundation color may be lighter than the first color and the first color may be lighter than the second color.

In an embodiment of the present invention, the foundation color may be darker than the first color and the first color may be darker than the second color.

In an embodiment of the present invention, the foundation color may be lighter than the first color, but darker than the second color.

In an embodiment of the present invention, the foundation color may be darker than the first color, but lighter than the second color.

In an embodiment of the present invention, the contrasting colored regions may be selected according to a particular environment for camouflage use.

In an embodiment of the present invention, the method may further comprise applying a third pattern comprising a plurality of irregularly shaped areas atop the second pattern. The third pattern may have a third color that is different from the second color, the first color, and the foundation color. The plurality of irregularly shaped areas of the third pattern may be surrounded by at least one of the first color of the first pattern, the second color of the second pattern, and the foundation color of the foundation material providing contrasting colored regions.

In an embodiment of the present invention, the plurality of irregularly shaped areas of the third pattern may be surrounded by each of the first color of the first pattern, the second color of the second pattern, and the foundation color of the foundation material.

In an embodiment of the present invention, the method may further comprise applying a fourth pattern comprising a plurality of irregularly shaped areas atop the third pattern. The fourth pattern may have a fourth color that is different from the third color, the second color, the first color, and the foundation color. The plurality of irregularly shaped areas of the fourth pattern may be surrounded by at least one of the first color of the first pattern, the second color of the second pattern, the third color of the third pattern, and the foundation color of the foundation material providing contrasting colored regions.

In an embodiment of the present invention, the plurality of irregularly shaped areas of the third pattern may be surrounded by each of the first color of the first pattern, the second color of the second pattern, the third color of the third pattern, and the foundation color of the foundation material.

In an embodiment of the present invention, the method may further comprise a plurality of spots overlaid atop the camouflage design. The plurality of spots may have a spot color and the spot color may be different from a color of a pattern area upon which the spots are overlaid.

In an embodiment of the present invention, the method may further comprise a plurality of first stripes overlaid atop the camouflage design. The plurality of first stripes may have a first stripe color and the first stripe color may be different from at least one color of a pattern area upon which the first stripes are overlaid.

In an embodiment of the present invention, the method may further comprise a plurality of pairs of contrasting second stripes, wherein a pair of the plurality of pairs of contrasting second stripes may be adjacent to and generally parallel with each first stripe. Each pair of contrasting second stripes may have a contrasting second stripe color that may be different from the first stripe color for which the pair is associated.

In an embodiment of the present invention, applying a pattern may comprise at least one of silk screen processing, embossing, printing, applique, quilting, tacking, gluing, pasting, stapling, stamping, sewing, and stitching.

In an embodiment of the present invention, the first pattern may comprise an area having a size sufficient to provide a base for subsequent additional pattern layers to be added thereto.

Aspects of the present invention may also be found in a camouflaged article prepared according to the method recited above. The camouflaged article may comprise at least one of a hat, shirt, jacket, pants, boots, belt, facial screen, bandana, tent, hammock, sleeping bag, cooler, canteen, cooking gear, gun sling, first aid bandages, tripod, ammunition belt, flashlight, backpack, shovel, binoculars, telescope, notebook, pencil, pen, folder, and binders.

These and various other advantages and features of novelty which may characterize the invention are pointed out with particularity in the claims annexed hereto and which form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

FIG. 1 illustrates a camouflage pattern displaying a plurality of irregularly shaped dark areas surrounded by progressively lighter and lighter areas according to an embodiment of the present invention;

FIG. 2 illustrates a camouflage pattern displaying a plurality of irregularly shaped light areas surrounded by progressively darker and darker areas according to an embodiment of the present invention; and

FIG. 3 illustrates a camouflage pattern displaying a plurality of irregularly shaped dark areas surrounded by intermittent lighter and darker areas and also display a plurality of dark streaks having adjacent light streaks overlaying the camouflage pattern according to an embodiment of the present invention.

### DETAILED DESCRIPTION OF THE INVENTION

One of nature's most uniquely camouflaged specimens is the morel mushroom, a type of monoascosporous mycelium, having at least the following genus and species names, Morchella esculenta, Morchella deliciosa, and Morchella angusticeps. Morel mushrooms have an unusual appearance, because they produce ascospores, which mean the spores are enclosed within the tissue of the mushroom. The mushroom's spores must therefore be near the surface, and a lot of surface area is needed for the release of the spores. Thus, morel mushrooms have ridges on the surface resulting in their sometimes being called “sponge mushrooms.”

Morel mushrooms, however, are nothing like sponges. They are hollow, rubbery, and brittle, much more brittle than other types of mushrooms. In fact, mushrooms usually have a tough skin over the surface and a fibrous stem, preventing pieces of mushroom tissue from breaking off. By contrast, morels crumble easy and are often broken, an inadequacy stemming from recent evolution from yeast.

The mushroom cap of the morel mushroom has many inadequacies, which other mushrooms have overcome through evolution. A typical mushroom cap protects spores from being washed away by rain, whereas the morel mushroom cap does not. The gills of mushrooms have aerodynamic properties for exploiting wind, whereas morel mushrooms cannot use wind nearly as effectively.

In other words, the use of ascospores by the morel mushroom was not a result of advantageous evolution, but rather a disadvantageous carryover from yeast from which the morel mushroom evolved. However, what morel mushrooms lack in reproductive capabilities, they more than make up for in camouflage techniques.

The largest division is between brown and black morel mushrooms. However, the browns blend into whites, with yellow and/or tan morel mushroom in between. The blacks also do not create a sharp break from the browns, as various types of grays are in between. Morel mushroom are also highly variable in size and shape. Cylindrical to cone shapes are perhaps the most common. Totally round morel mushrooms are not uncommon. Pencil shaped morel mushrooms are more rare. The appearance of morel mushrooms is specific to an area; and therefore, their identification should include their location. However, they also vary within locations, as shown in the research section.

Major steps in evolution are obscure, because they occur rapidly leaving evidence only of the before and after. The morel mushroom is in a transitional stage of evolution allowing the process to be visible. The result is stunning biology that shows unheard of effects including phenotypic variations, regional genotypic variations, pigmented mycelium, and a reversion anomaly. The morel mushroom began evolving from yeast during the last ice age, about 100 thousand years ago, which is a very short time in evolution. It is still undergoing rapid and dramatic change as a result.

Mushrooms are usually quite ancient in their evolution, which makes them hardy and easy to handle, as difficult as mushrooms can be to handle. Morel mushrooms, however, are in the infancy of their evolution, which makes them very fragile to handle. Morel mushrooms may seem to be ubiquitous, but they are environmentally fragile, and they do not disseminate well. The fragility of morel mushrooms has led to the evolution of a sophisticated camouflage technique that renders the morel mushroom nearly invisible in plain sight.

The morel mushroom is provided with a plurality of encircled orifices along the outer surface of the mushroom cap. These orifices create an optical effect of light and shadow that makes the morel mushroom very difficult to locate, even by expert mushroom hunters. It is this interplay of light and shadow, light and dark, contrasting colored regions, which inspired the camouflage method and articles prepared using the method of the present invention.

It is the study of these fascinating, naturally well camouflaged, and hard to find mushrooms that provides inspiration for the camouflage pattern and method of providing camouflage disclosed below. The camouflage pattern disclosed below is not identical to the pattern disclosed by morel mushrooms in nature, but as set forth above, the elusive nature of the morel mushroom provided the mental inspiration for the camouflage method and patterns disclosed herein.

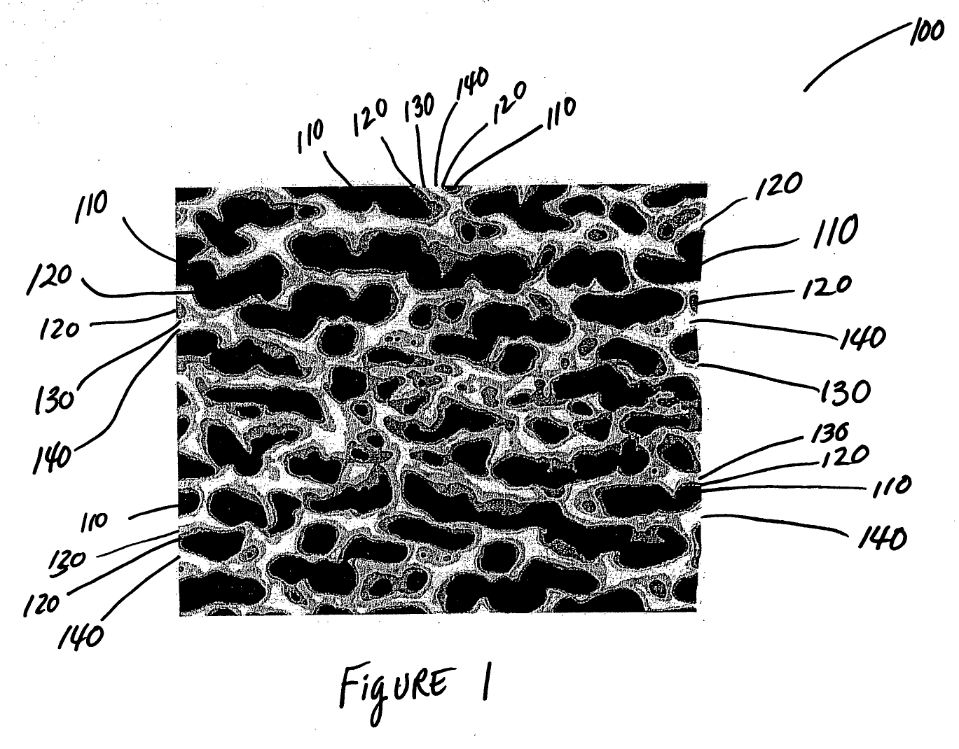

FIG. 1 illustrates a camouflage pattern 100 displaying a plurality of first irregularly shaped dark areas 110 surrounded by progressively lighter and lighter (second 120, third 130, fourth 140, etc., although only four contrasts of shading, 110, 120, 130, and 140, have been disclosed in FIG. 1, multiple and numerous additional contrasts may be provided as desired and necessary for a particular camouflage environment) areas according to an embodiment of the present invention. In an embodiment of the present invention, the pattern may comprise a plurality of regularly shaped areas or a combination of a plurality of regularly shaped areas and irregularly shaped areas. In an embodiment of the invention, be fabricated as a single ply or multi-ply material.

Disclosed in FIG. 1 are pluralities of first irregularly shaped dark areas 110. Each of the first irregularly shaped dark areas 110 is surrounded and enclosed by a second lighter irregularly shaped area 120. The surrounding second lighter irregularly shaped areas 120 may generally follow the irregular shape of the first irregularly shaped dark areas 110, or alternatively may have a completely different irregular shape than the first irregularly shaped dark areas 110. In an embodiment of the present invention, the pattern may comprise a plurality of regularly shaped areas or a combination of a plurality of regularly shaped areas and irregularly shaped areas. In an embodiment of the invention, be fabricated as a single ply or multi-ply material.

The second lighter irregularly shaped areas 120 surrounding the first dark irregularly shape areas 110 may also be surrounded by a third even lighter area 130 which surrounds and encloses at least one of the first dark areas 110. Several first dark areas 110 and their surrounding second lighter areas 120 may also be surrounded by the third even lighter areas 130, or alternatively a single first dark area 110 may be surrounded by the second lighter area 120 and the third even lighter area 130. In an embodiment of the present invention, the pattern may comprise a plurality of regularly shaped areas or a combination of a plurality of regularly shaped areas and irregularly shaped areas. In an embodiment of the invention, be fabricated as a single ply or multi-ply material.

Pluralities of fourth much lighter 140 areas are also displayed in FIG. 1. The fourth much lighter areas 140 may surround a first dark area 110, a first dark area and a second lighter area 120, a first dark area 110 and second lighter area 120 and third even lighter area 130, and various combinations thereof. The function of providing the multiple first dark areas 110 surrounded and enclosed by the progressively lighter and lighter areas, or intermittent light and dark areas, mimics the natural effects of light and shadow creating an optical effect which causes the bearer of the camouflage pattern to become invisible in plain sight. In an embodiment of the present invention, the pattern may comprise a plurality of regularly shaped areas or a combination of a plurality of regularly shaped areas and irregularly shaped areas. In an embodiment of the invention, be fabricated as a single ply or multi-ply material.

The following method for producing such a camouflage pattern is but one exemplary method. Other methods of producing the camouflage pattern are envisioned. In an embodiment of the present invention, a light colored material may form the foundation or base for the camouflage pattern. The light colored material may be a fabric, textile, paper, wood, metal, netting, open weave, or some other material, as desired.

A first pattern being darker than the light colored material may be applied to the light colored material. The first pattern may be applied through numerous techniques such as silk screen, embossing, printing, applique, quilting, tacking, gluing, pasting, stapling, stamping, sewing, stitching, etc. The first pattern may have an area large enough to provide a foundation or a base for subsequent additional pattern layers to be added to the camouflage apparatus. In an embodiment of the invention, be fabricated as a single ply or multi-ply material.

A second pattern, which may be darker or lighter than the first pattern may then be applied atop the first pattern and attached thereto according to one of techniques recited above. A third, fourth, and subsequent additional patterns may be applied atop the first and second patterns atop the light colored material until the desired layering of patterns is achieved. In an embodiment of the invention, be fabricated as a single ply or multi-ply material.

In an embodiment of the present invention, the foundation material may be fabricated having both sides of the material displaying the camouflage pattern. For example, the material may be formed through a weaving or textile making technique using a plurality of differently colored threads. The resulting camouflage material may be lighter in weight but still display the above disclosed shapes and shaped patterns. The foundation material manufactured according to an embodiment of the present invention may be single ply or multi-ply. The foundation material manufactured according to an embodiment of the present invention may be see-through, permitting the material to be worn over the face of a user, or alternatively, be used to form a camouflage shelter where an individual inside the shelter may look through the walls and observe, without being observed by others, (to be invisible in plain sight).

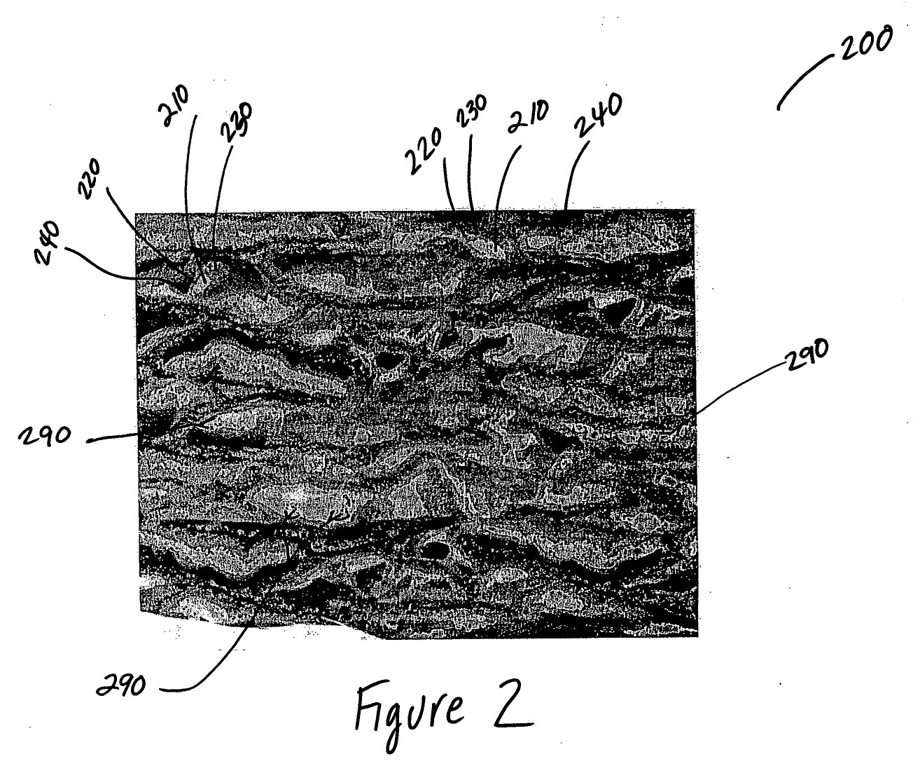

FIG. 2 illustrates a camouflage pattern 200 displaying a plurality of irregularly shaped light areas 210 surrounded by progressively darker and darker areas (second 120, third 130, fourth 140, etc., although only four contrasts of shading, 110, 120, 130, and 140, have been disclosed in FIG. 2, multiple and numerous additional contrasts may be provided as desired and necessary for a particular camouflage environment) areas according to an embodiment of the present invention. In an embodiment of the present invention, the pattern may comprise a plurality of regularly shaped areas or a combination of a plurality of regularly shaped areas and irregularly shaped areas. In an embodiment of the invention, be fabricated as a single ply or multi-ply material.

Disclosed in FIG. 2 are pluralities of first irregularly shaped light areas 210. Each of the first irregularly shaped dark areas 210 is surrounded and enclosed by a second darker irregularly shaped area 220. The surrounding second darker irregularly shaped areas 220 may generally follow the irregular shape of the first irregularly shaped light areas 210, or alternatively may have a completely different irregular shape than the first irregularly shaped dark areas 210. In an embodiment of the present invention, the pattern may comprise a plurality of regularly shaped areas or a combination of a plurality of regularly shaped areas and irregularly shaped areas. In an embodiment of the invention, be fabricated as a single ply or multi-ply material.

The second darker irregularly shaped areas 220 surrounding the first light irregularly shape areas 210 may also be surrounded by a third even darker area 230 which surrounds and encloses at least one of the first light areas 210. Several first light areas 210 and their surrounding second darker areas 220 may also be surrounded by the third even darker areas 230, or alternatively a single first light area 210 may be surrounded by the second darker area 220 and the third even darker area 230. In an embodiment of the present invention, the pattern may comprise a plurality of regularly shaped areas or a combination of a plurality of regularly shaped areas and irregularly shaped areas. In an embodiment of the invention, be fabricated as a single ply or multi-ply material.

Pluralities of fourth much darker 240 areas are also displayed in FIG. 2. The fourth much darker areas 240 may surround a first light area 210, a first light area 210 and a second darker area 220, a first light area 210 and second darker area 220 and third even darker area 230, and various combinations thereof. The camouflage pattern 200 may also be provided with a plurality of dark spots 290 applied atop the light areas 120. The dark contrasting spots 290 may be applied last to the camouflage article as a final layer (see method below). The function of providing the multiple first light areas 210 surrounded and enclosed by the progressively darker and darker areas, or intermittent light and dark areas, mimics the natural effects of light and shadow creating an optical effect which causes the bearer of the camouflage pattern to become invisible in plain sight. In an embodiment of the present invention, the pattern may comprise a plurality of regularly shaped areas or a combination of a plurality of regularly shaped areas and irregularly shaped areas. In an embodiment of the invention, be fabricated as a single ply or multi-ply material.

The following method for producing such a camouflage pattern is but one exemplary method. Other methods of producing the camouflage pattern are envisioned. In an embodiment of the present invention, a dark colored material may form the foundation or base for the camouflage pattern. The dark colored material may be a fabric, textile, paper, wood, metal, netting, open weave, or some other material, as desired.

A first pattern being lighter than the dark colored material may be applied to the dark colored material. The first pattern may be applied through numerous techniques such as silk screen, embossing, printing, applique, quilting, tacking, gluing, pasting, stapling, stamping, sewing, stitching, etc. The first pattern may have an area large enough to provide a foundation or a base for subsequent additional pattern layers to be added to the camouflage apparatus. In an embodiment of the invention, be fabricated as a single ply or multi-ply material.

A second pattern, which may be darker or lighter than the first pattern may then be applied atop the first pattern and attached thereto according to one of techniques recited above. A third, fourth, and subsequent additional patterns may be applied atop the first and second patterns atop the dark colored material until the desired layering of patterns is achieved. A plurality of dark spots 290 (irregularly or regularly shaped specks) may be applied atop the light areas 210 as a final layered according to the techniques set forth above. In an embodiment of the invention, be fabricated as a single ply or multi-ply material.

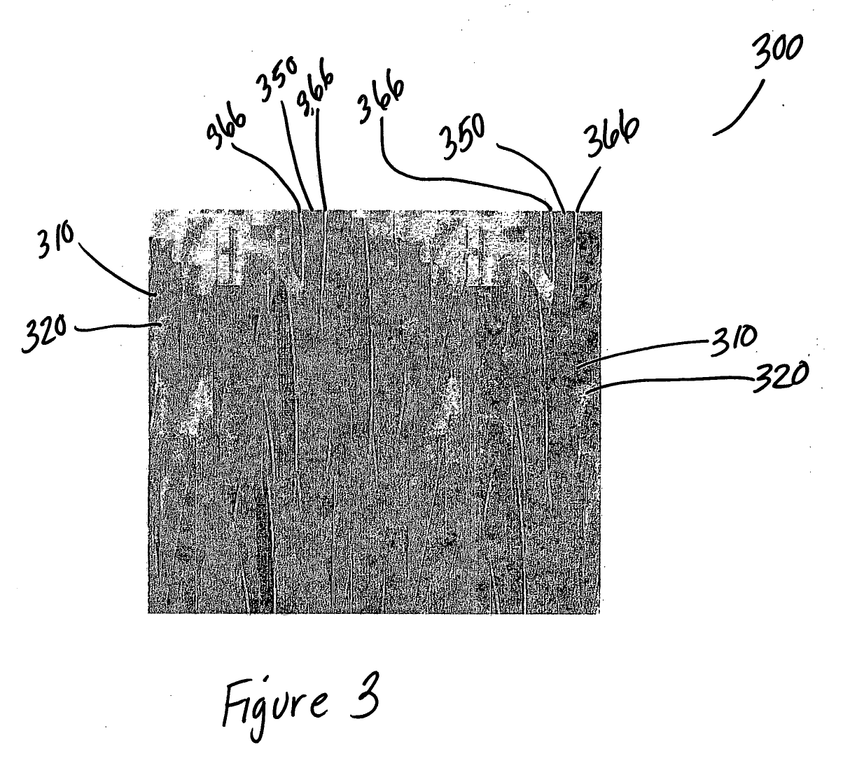

FIG. 3 illustrates a camouflage pattern 300 displaying a plurality of irregularly shaped dark areas 310 surrounded by intermittent lighter and darker areas 320 and also display a plurality of dark streaks 350 having adjacent light streaks 366 overlaying the irregularly shaped areas according to an embodiment of the present invention. FIG. 3 illustrates a camouflage pattern 300 displaying a plurality of irregularly shaped dark areas 310 surrounded by progressively lighter areas (second 120, etc., although only two contrasts of shading, 310 and 320, have been disclosed in FIG. 3, multiple and numerous additional contrasts may be provided as desired and necessary for a particular camouflage environment) areas according to an embodiment of the present invention. In an embodiment of the present invention, the pattern may comprise a plurality of regularly shaped areas or a combination of a plurality of regularly shaped areas and irregularly shaped areas. In an embodiment of the invention, be fabricated as a single ply or multi-ply material.

Disclosed in FIG. 3 are pluralities of first irregularly shaped dark areas 310. Each of the first irregularly shaped dark areas 310 is surrounded and enclosed by a second lighter irregularly shaped area 320. The surrounding second lighter irregularly shaped areas 320 may generally follow the irregular shape of the first irregularly shaped light areas 310, or alternatively may have a completely different irregular shape than the first irregularly shaped dark areas 310. In an embodiment of the present invention, the pattern may comprise a plurality of regularly shaped areas or a combination of a plurality of regularly shaped areas and irregularly shaped areas. In an embodiment of the invention, be fabricated as a single ply or multi-ply material.

The second darker irregularly shaped areas 320 surrounding the first light irregularly shape areas 310 may also be surrounded by a third even lighter area which may also surround and enclose at least one of the first light areas 310 (not shown). Several first dark areas 310 and their surrounding second lighter areas 320 may also be surrounded by the third even lighter areas, or alternatively a single first light area 310 may be surrounded by the second darker area 320 and the third even lighter area (not shown). In an embodiment of the present invention, the pattern may comprise a plurality of regularly shaped areas or a combination of a plurality of regularly shaped areas and irregularly shaped areas. In an embodiment of the invention, be fabricated as a single ply or multi-ply material.

A plurality of fourth much lighter or much darker areas may also be applied. The fourth much darker or much lighter areas may surround a first light area 310, a first dark area 310 and a second lighter area 320, a first dark area 310 and second lighter area 320 and third even darker area, and various combinations thereof. The camouflage pattern 300 may also be provided with a plurality of light or dark spots applied atop the dark areas 310. The light or dark contrasting spots may be applied last to the camouflage article as a final layer or an intermediate layer (see method below). In an embodiment of the present invention, the pattern may comprise a plurality of regularly shaped areas or a combination of a plurality of regularly shaped areas and irregularly shaped areas. In an embodiment of the invention, be fabricated as a single ply or multi-ply material.

The camouflage article or apparatus may also be provided with large stripes or streaks 350 of contrasting shade across and overlaying the irregularly shaped camouflage patterns 300. The large stripes or streaks 350 may be dark (as shown in FIG. 3) or may also be light shaded. The large streaks or stripes may be accompanied by generally parallel high contrast smaller streaks or stripes. For example if the large streak is dark, the accompanying lighter adjacent and generally parallel smaller stripes or streaks should contrast and be lighter, and vice versa. In an embodiment of the present invention, the pattern may comprise a plurality of regularly shaped areas or a combination of a plurality of regularly shaped areas and irregularly shaped areas.

These additional camouflage embellishments may provide further optical effects and further break up the outline of a camouflaged apparatus or article. The function of providing the multiple first dark areas 310 surrounded and enclosed by the progressively lighter and darker areas, or intermittent light and dark areas, mimics the natural effects of light and shadow creating an optical effect which causes the bearer of the camouflage pattern to become invisible in plain sight.

The following method for producing such a camouflage pattern is but one exemplary method. Other methods of producing the camouflage pattern are envisioned. In an embodiment of the present invention, a light colored material may form the foundation or base for the camouflage pattern. The light colored material may be a fabric, natural fibers, synthetic fibers, a composite of natural and synthetic fibers, textiles, papers, wood materials and wood byproducts, metal, netting, open weave, plastics, nylon fibers, or some other material, as desired. The materials may be adapted to employ snaps, zippers, buttons, loops, eyes, hook and eye fasteners, hooks, and other fastening devices, to connect one portion of the material to another portion of the material, or connect one portion of the material to another material or structure. In an embodiment of the invention, be fabricated as a single ply or multi-ply material.

A first pattern being darker than the light colored material may be applied to the light colored material. The first pattern may be applied through numerous techniques such as silk screen, embossing, printing, applique, quilting, tacking, gluing, pasting, stapling, stamping, sewing, stitching, weaving, looming, etc. The first pattern may have an area large enough to provide a foundation or a base for subsequent additional pattern layers to be added to the camouflage apparatus, or in an embodiment of the invention, be fabricated as a single ply or multi-ply material.

A second pattern, which may be darker or lighter than the first pattern may then be applied atop the first pattern and attached thereto according to one of techniques recited above. A third, fourth, and subsequent additional patterns may be applied atop the first and second patterns atop the dark colored material until the desired layering of patterns is achieved. A plurality of light or dark spots (irregularly or regularly shaped specks) may be applied atop the light or dark areas, in contrast thereof, as a final layer or as an intermediate layer according to the techniques set forth above. In an embodiment of the present invention, the material may be fabricated as a single ply or multi-ply material.

Additionally, a plurality of large dark or light streaks or stripes may be provided atop the camouflage pattern as an overlay, wherein each of the large streaks or stripes may be accompanied by at least a pair of high contrast and smaller generally parallel streaks or stripes to provide additional contrast to the camouflage article or apparatus.

The colors used in producing the camouflaged articles or apparatus may be chosen to provide a particular optical effect in a particular environment. For example, in snowy terrain, such as tundra, taiga, and Polar Regions, the colors may be selected from varying shades of white, grey, and black. In desert areas, tans and browns may be selected. In woodland areas, grays, greens, browns, and blacks may be selected. In the plains, tans, browns, grays, reds, and blacks may be selected. In swamp regions, grays, blacks, brown, and dark blues and greens may be selected. In watery regions, blues, and grays and whites may be selected. The camouflage pattern may be designed for a particular region based upon the surroundings of the particular environment.

Numerous articles are envisioned for the application of the camouflage method disclosed herein. For example, clothing (hats, shirts, jackets, pants, boots, belts, facial screens, bandanas, etc.), camping supplies (tents, hammocks, sleeping bags, coolers, canteens, cooking gear, etc.), military supplies (gun slings, first aid bandages, tripods, ammunition belts, flashlights, backpacks, shovels, etc.), bird watching equipment (binoculars, telescopes, notebooks, pencils, pens, folders, binders, etc.), and numerous other items.

Although a method and apparatus according to the present invention has been described in connection with the preferred embodiment, it is not intended to be limited to the specific form set forth herein, but on the contrary, it is intended to cover such alternatives, modifications, and equivalents, as can be reasonably included within the spirit and scope of the invention as defined by this disclosure and appended diagrams. It is intended that the scope of the invention be limited not with this detailed description but rather by the claims appended hereto.

What is claimed is:

1. A method of camouflaging an article, the method comprising:
preparing a foundation material to be camouflaged, the foundation material having a foundation color;
applying a first pattern comprising a plurality of irregularly shaped areas atop the foundation material, the first pattern having a first color being different from the foundation color; and
applying a second pattern comprising a plurality of irregularly shaped areas atop the first pattern, the second pattern having a second color being different from the first color and the foundation color, wherein the plurality of irregularly shaped areas of the second pattern are surrounded by at least one of the first color of the first pattern and the foundation color of the foundation material providing contrasting colored regions.

2. The method according to claim 1, wherein the plurality of irregularly shaped areas of the second pattern are surrounded by at least both of the first color of the first pattern and the foundation color of the foundation material.

3. The method according to claim 1, wherein the foundation color is lighter than the first color and the first color is lighter than the second color.

4. The method according to claim 1, wherein the foundation color is darker than the first color and the first color is darker than the second color.

5. The method according to claim 1, wherein the foundation color is lighter than the first color, but darker than the second color.

6. The method according to claim 1, wherein the foundation color is darker than the first color, but lighter than the second color.

7. The method according to claim 1, wherein the contrasting colored regions are selected according to a particular environment for camouflage use, and the article is visually translucent.

8. The method according to claim 1, further comprising:
applying a third pattern comprising a plurality of irregularly shaped areas atop the second pattern, the third pattern having a third color being different from the second color, the first color, and the foundation color, wherein the plurality of irregularly shaped areas of the third pattern are surrounded by at least one of the first color of the first pattern, the second color of the second pattern, and the foundation color of the foundation material providing contrasting colored regions.

9. The method according to claim 8, wherein the plurality of irregularly shaped areas of the third pattern are surrounded by each of the first color of the first pattern, the second color of the second pattern, and the foundation color of the foundation material.

10. The method according to claim 8, further comprising:
applying a fourth pattern comprising a plurality of irregularly shaped areas atop the third pattern, the fourth pattern having a fourth color being different from the third color, the second color, the first color, and the foundation color, wherein the plurality of irregularly shaped areas of the fourth pattern are surrounded by at least one of the first color of the first pattern, the second color of the second pattern, the third color of the third pattern, and the foundation color of the foundation material providing contrasting colored regions.

11. The method according to claim 10, wherein the plurality of irregularly shaped areas of the third pattern are surrounded by each of the first color of the first pattern, the second color of the second pattern, the third color of the third pattern, and the foundation color of the foundation material.

12. The method according to claim 1, further comprising a plurality of spots overlaid atop the camouflage design, wherein the plurality of spots have a spot color and the spot color is different from a color of a pattern area upon which the spots are overlaid.

13. The method according to claim 1, further comprising a plurality of first stripes overlaid atop the camouflage design, wherein the plurality of first stripes have a first stripe color and the first stripe color is different from at least one color of a pattern area upon which the first stripes are overlaid.

14. The method according to claim 13, further comprising a plurality of pairs of contrasting second stripes, wherein a pair of the plurality of pairs of contrasting second stripes being adjacent and generally parallel to each first stripe, each pair of contrasting second stripes having a contrasting second stripe color which is different from the first stripe color for which the pair is associated.

15. The method according to claim 1, wherein applying a pattern further comprises at least one of silk screen processing, embossing, printing, applique, quilting, tacking, gluing, pasting, stapling, stamping, sewing, and stitching.

16. The method according to claim 1, wherein the first pattern comprises an area having a size sufficient to provide a base for subsequent additional pattern layers to be added thereto.

17. A method of camouflaging an article, the method comprising:
preparing a foundation material comprising at least one ply to be camouflaged, the foundation material having a foundation color;
fabricating the article with a first pattern comprising a plurality of shaped areas disposed within the foundation material, the first pattern having a first color being different from the foundation color; and
fabricating the article with a second pattern comprising a plurality of shaped areas disposed within the first pattern, the second pattern having a second color being different from the first color and the foundation color, wherein the plurality of shaped areas of the second pattern are surrounded by at least one of the first color of the first pattern and the foundation color of the foundation material providing contrasting colored regions.

18. The method according to claim 17, wherein the foundation material having at least one ply further comprises one of a single ply material, a two ply material, and a multi-ply material, and the plurality of shaped areas further comprise at least one of a plurality of regularly shaped areas, a plurality of irregularly shaped areas, and a combination of regularly and irregularly shaped areas.

19. The method according to claim 17, wherein the plurality of shaped areas further comprise at least one of a plurality of regularly shaped areas, a plurality of irregularly shaped areas, and a combination of regularly and irregularly shaped areas.

20. A camouflaged article prepared according to the method claim 1, wherein the camouflaged article comprises at least one of a hat, shirt, jacket, pants, boots, belt, facial screen, bandana, tent, hammock, sleeping bag, cooler, canteen, cooking gear, gun sling, first aid bandages, tripod, ammunition belt, flashlight, backpack, shovel, binoculars, telescope, notebook, pencil, pen, folder, and binders.
